(19) United States
(12) Patent Application Publication
(10) Pub. No.: US 2021/0009805 A1
(43) Pub. Date: Jan. 14, 2021

(54) Non-pneumatic tire comprising polyurethane matrix and expanded thermoplastic elastomer particles

(71) Applicant: BASF SE, Ludwigshafen am Rhein (DE)

(72) Inventors: Zhen Peng LIANG, Guangzhou (CN); Yun Bang Zhong, Guangzhou (CN)

(73) Assignee: BASF SE, Ludwigshafen am Rhein (DE)

(21) Appl. No.: 15/733,671

(22) PCT Filed: Mar. 27, 2019
(86) PCT No.: PCT/EP2019/057680

§ 371 Date: Sep. 28, 2020

(30) Foreign Application Priority Data
Mar. 30, 2018 (CN) 201810278618.2

(51) Int. Cl. C08L 75/08; B60C 1/00

(52) U.S. Cl. CPC C08L 75/08; B60C 1/00; C08L 2207/04; B60C 2001/0091; C08L 2205/025; C08L 2207/02; C08L 2205/18

(57) ABSTRACT

A non-pneumatic tire may include a polyurethane matrix and expanded thermoplastic elastomer particles. The non-pneumatic tire has 60 to 90 wt. % of the polyurethane matrix and 10 to 40 wt. % of the expanded thermoplastic elastomer particles. The non-pneumatic tire may be produced in a production method. The non-pneumatic tire may be used in a low-speed vehicle.

### TECHNICAL FIELD

The present invention relates to a non-pneumatic tire, a method of producing a non-pneumatic tire, and preferably use of the non-pneumatic tire in a low-speed vehicle such as a bicycle, a monocycle, a trolley, a construction vehicle, a lawnmower, a golf trolley, a haul truck, a wheelchair, an electric scooter, a scooter, and an electric bicycle.

### BACKGROUND OF ARTS

Pneumatic tires have been widely used in bicycles, cars, trucks, airplanes, etc. In these applications, travel quality and comfort are important parts of vehicle performance. However, pneumatic tires are very sensitive to cracks, punctures and/or other damage that can lead to leak of tire. Tires need to be repaired or replaced when there is a leak, resulting in more financial burden. More seriously, if tire leaks abruptly, such as bursting, it can cause safety problems.

As an alternative, non-pneumatic tires appeared. Unlike pneumatic tires, non-pneumatic tires do not suffer from leaks. A variety of non-pneumatic tires have been developed.

CN1715041A discloses a non-pneumatic tire and a method of manufacturing the same, wherein the filler component comprises a polyurethane, which has a Shore A hardness of about 68 to about 75.

CN106188493A discloses a composition for expanded polyurethane tire, wherein tires made of the composition have a density of 400-500 kg/m³ and a Shore A hardness of 65-90.

WO2017/039451A1 discloses a wheel assembly comprising a non-pneumatic tire wherein the non-pneumatic tire is made of a foamed polymer, such as expanded thermoplastic polyurethanes (E-TPU).

CN105939870A discloses a polyurethane-filled tire made of a porous polyurethane or polyurethane-urea elastic material having a Shore A hardness of 45-80 as measured according to ASTM D2240 and a rebound resilience of 40-70% as measured according to ASTM D3574.

CN101583656A discloses a hybrid material comprising a matrix of polyurethane and foamed particles of thermoplastic polyurethane comprised therein and also a process for producing such hybrid materials and the use of these hybrid materials as floor covering, bicycle saddles, upholstery and shoe soles.

US 2010/0122758 A1 discloses a tire comprising a foam part made of a rubber or plastic material and a hollow elastic part present in the foam part, the hollow elastic part being made of rubber or thermoelastic rubber.

CN105346332A discloses a tire, wherein the tire casing is made of polyurethane material and the tire core is made by molding E-TPU particles.

CN104309411A discloses a thermoplastic polyurethane low load tire comprising a surface layer for direct contact with the ground and an inner layer located inside the surface layer, wherein the surface layer has a higher hardness than the inner layer, and the surface layer and the inner layer are formed by molding E-TPU particles.

CN104290539A discloses a tire in which numerous E-TPU elastic closed cell particles are placed in the space formed by the tire casing and the wheel hub, and are adhered together by using an adhesive or a surface hot melt process.

Although a wide variety of non-pneumatic tires have been developed, these non-pneumatic tires generally have the disadvantage of being heavy and poor in rebound resilience compared to pneumatic tires. Therefore, there is still a need to further provide a non-pneumatic tire with light weight and good rebound resilience.

### INVENTION SUMMARY

The present invention provides a non-pneumatic tire comprising 60 to 90 wt % of a polyurethane matrix and 10 to 40 wt % of expanded thermoplastic elastomer particles.

The present invention also provides a method of producing a non-pneumatic tire comprising the steps of:

(1) placing expanded thermoplastic elastomer particles in a mold;

(2) injecting a polyurethane matrix into the mold and curing; and

(3) demoulding.

In addition, the present invention provides use of the non-pneumatic tire in a vehicle, preferably a low-speed vehicle such as a bicycle, a monocycle, a trolley, a construction vehicle, a lawnmower, a golf trolley, a haul truck, a wheelchair, an electric scooter, a scooter, and an electric bicycle.

The non-pneumatic tire of the invention has the advantages of one or more of light weight, high rebound resilience and good cushioning effect.

### BRIEF DESCRIPTION OF THE DRAWINGS

FIG. 1 is a cross-sectional view of a non-pneumatic tire according to the present invention (Example 1), in which E-TPU particles are dispersed in a polyurethane matrix.

FIG. 2 is a cross-sectional view of a dual-density integrated tire according to the present invention (Example 3), in which the double-density integrated tire comprises a textured outer tire portion (deep-colored portion) and an inner tire portion (light-colored portion).

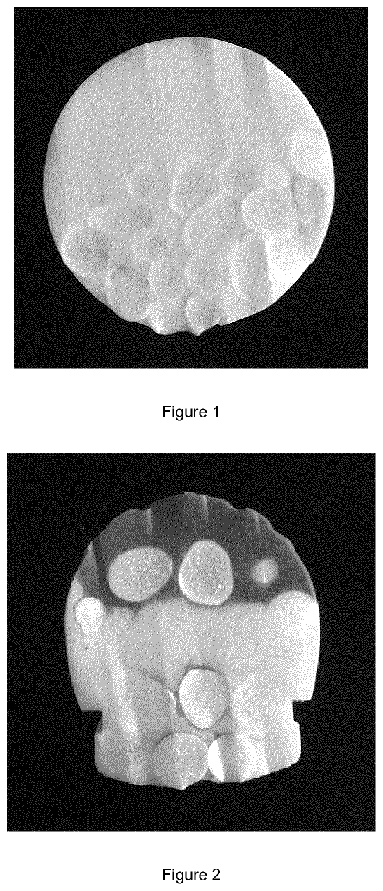

### EMBODIMENTS

In one embodiment of the present invention, there is provided a non-pneumatic tire comprising 60 to 90 wt % of a polyurethane matrix and 10 to 40 wt % of expanded thermoplastic elastomer particles. Preferably, the non-pneumatic tire comprises 80 to 90 wt % of a polyurethane matrix and 10 to 20 wt % of expanded thermoplastic elastomer particles.

The non-pneumatic tire has a Shore A hardness of 40-90, preferably 54-56.

The non-pneumatic tire has a rebound resilience of 45-65%, preferably 50-60%.

The non-pneumatic tire has a density of 300-900 kg/m³, preferably 450-600 kg/m³. The expanded thermoplastic elastomer particles have a density of 200-300 kg/m³.

In one embodiment of the invention, the expanded thermoplastic elastomer particles have a diameter of 1 to 15 mm, preferably 4 to 7 mm, and are preferably spherical or oval. In the case of non-spherical shapes, such as oval particles, the diameter is in terms of the long axis.

### Polyurethane Matrix

According to the invention, the polyurethane matrix is prepared, for example, by reaction of an isocyanate with an isocyanate-reactive compound having a number molecular weight of 500 to 10,000 optionally with a chain extender, optionally in the presence of a catalyst and/or customary auxiliaries and/or additives.

As isocyanates , it is possible to use aliphatic, alicyclic, araliphatic and/or aromatic isocyanates and/or isocyanate prepolymers, preferably diisocyanates such as tri-, tetra-, penta-, hexa-, hepta- and/or octa-methylene diisocyanate, 2-methylpentamethylene-1,5-diisocyanate, 2-ethylbutylene-1,4-diisocyanate, pentamethylene-1,5-diisocyanate, butylene-1,4-diisocyanate, 1-isocyanato-3,3,5-trimethyl-5-isocyanatomethylcyclohexane (isophorone diisocyanate, IPDI), 1,4- and/or 1,3-bis (isocyanatomethyl) cyclohexane (HXDI), cyclohexane-1,4-diisocyanate, 1-methylcyclohexane-2,4- and/or 2,6-diisocyanates, and/or dicyclohexylmethane-4,4′-, 2,4′- and 2,2′-diisocyanates, diphenylmethane diisocyanate such as diphenylmethane-2,2′-, 2,4′- and/or 4,4′-diisocyanate (MDI), naphthylene-1,5-diisocyanate (NDI), tolylene-2,4- and/or 2,6-diisocyanate (TDI), 3,3 ′-dimethyldiphenyl diisocyanate, 1,2-diphenylethane diisocyanate, and/or phenylene diisocyanate.

As isocyanate-reactive compounds , it is possible to use isocyanate-reactive compounds, such as polyester polyols, polyether polyols and/or polycarbonate diols, and mixtures thereof, which are usually classified under the term “polyol” and have a number average molecular weight of 500 to 8,000 g/mol, preferably 600 to 6,000 g/mol, and preferably have an average functionality of 1.8 to 3.3, in particular 2.0 to 3.0.

As chain extenders, it is possible to use aliphatic, araliphatic, aromatic and/or alicyclic compounds having a number molecular weight of from 50 to 499, preferably bifunctional compounds, such as diamines and/or alkanediols having 2 to 10 carbon atoms, in particular 1,4-butanediol, 1,6-hexanediol, and/or dialkylene glycols, trialkylene glycols , Tetra alkylene glycols, pentaalkylene glycols, hexaalkylene glycols, heptaalkylene glycols, octaalkylene glycols, nonaalkylene glycols and/or decaalkylene glycols having 3 to 10 carbon atoms, preferably the corresponding oligopropylene glycol and/or polypropylene glycol, but also mixtures of these chain extenders.

As a suitable catalyst for promoting the reaction between NCO groups of the isocyanate and the hydroxyl groups, tertiary amines such as amine gel type catalysts, triethylamine, dimethylcyclohexylamine, N-methylmorpholine, N,N′-dimethylpiperazine, 2-(dimethylaminoethoxy) ethanol, diazabicyclo [2.2.2] octane and the like, and organometallic compounds such as titanates, iron compounds such as acetyl Iron (III) pyruvate, tin compounds such as tin diacetate, tin dioctoate, tin dilaurate, or dialkyl tin salts of aliphatic carboxylic acids such as dibutyltin diacetate, dibutyltin dilaurate and the like can be used. The catalyst is usually used in an amount of 0.0001-4.0 parts by weight based on 100 parts by weight of the weight of the polyurethane matrix.

In addition to the catalysts, customary auxiliaries and/or additives may also be added. Examples which may be mentioned comprise foaming agents, foam stabilizers, surface-active substances, fillers, flame retardants, nucleating agents, oxidation stabilizers, lubricants and mold-release agents, dyes , pigments, reinforcing materials, thickener, and plasticizers.

This reaction can be carried out under conventional index, preferably from 60 to 120, particularly preferably from 80 to 110. The index is defined as the ratio of the total number of isocyanate groups to the isocyanate-reactive groups (e.g. active hydrogen atoms) used in the reaction.

The polyurethane matrix can be in the form of a foam or compacted elastomer.

### Expanded Thermoplastic Elastomer Particles

In embodiments of the present invention, the expanded thermoplastic elastomer particles comprise expanded (i.e. formed) thermoplastic polyurethane particles; expanded thermoplastic polyester ether particles; expanded thermoplastic polyether ester particles; expanded thermoplastic polyether amide particles; expanded thermoplastic polyolefin particles such as expanded thermoplastic polyethylene vinyl acetate particles, expanded thermoplastic polyethylene propylene diene particles, expanded thermoplastic polypropylene particles, expanded thermoplastic styrene block copolymer particles; and mixtures thereof.

Preferably, the expanded thermoplastic elastomer particles are expanded thermoplastic polyurethane (E-TPU) particles.

The expanded thermoplastic polyurethane particles can be produced from thermoplastic polyurethane by suspension or extrusion methods known to those skilled in the art and are described in the above documents. Among these methods, the expanded thermoplastic polyurethane particles can be obtained directly or indirectly.

In the suspension process, the particulate thermoplastic polyurethane is heated in a closed reactor with water, suspending agent and foaming agent to above the softening temperature of the particulate material. The polymer particles here are impregnated with a foaming agent. One possibility is to cool the hot suspension, then the particles harden in the presence of a foaming agent and the reactor is depressurized. The resultant expandable particles containing a foaming agent are foamed by heating in a subsequent step to obtain foamed particles. In another alternative, the hot suspension may be suddenly depressurized without cooling (explosion expansion process), so the softening particles containing a foaming agent are immediately foamed to produce foamed particles, see, for example, WO 94/20568.

In the extrusion process, the thermoplastic polyurethane is melt and mixed in an extruder with a foaming agent introduced into the extruder. The mixture containing the foaming agent is extruded and pelletized under pressure and temperature such that the particulate thermoplastic polyurethane material is not foamed (expanded), which can be achieved, for example, by using granulator under water that is operated at a water pressure in excess of 2 bars. This produces expandable particles containing a foaming agent, and is foamed by heating in a subsequent step to obtain foamed particles. Alternatively, it is also possible to extrude and granulate the mixture without using super atmospheric pressure. In this method, molten strand foam and foamed particles are obtained by pelletization.

The present invention also provides a method of producing a non-pneumatic tire comprising:

(1) placing expanded thermoplastic elastomer particles in a mold;

(2) injecting a polyurethane matrix into the mold and curing; and

(3) demoulding.

The invention also relates to the use of a non-pneumatic tire in a vehicle, preferably a low-speed vehicle such as a vehicle having a speed of less than 40 km/h, preferably less than 30 km/h. The vehicles include a bicycle, a monocycle, a trolley, a construction vehicle, a lawnmower, a golf trolley, a haul truck, a wheelchair, an electric scooter, a scooter, and an electric bicycle.

### EXAMPLES

The invention is illustrated in conjunction with the following examples and figures, which are for illustrative purposes only and should not be construed as limiting the scope of the invention.

The starting materials used in the examples are as follows:

Polyol-A: polyether polyol with a number average molecular weight of 6,000, a functionality of 3 and a hydroxyl value of about 28 mg KOH/g, obtained from Tianjin Petrochemical Company under TEP-3600;

Polyol-B: Polyether polyol with a number average molecular weight of 4,000, a functionality of 2, a hydroxyl value of about 28 mg KOH/g, obtained from Tianjin Petrochemical Company under TED-28;

Polyol-C: Styrene-acrylonitrile copolymerization grafted polyether polyol with a solid content of about 45% and a hydroxyl value of about 21 mg KOH/g, obtained from Zibo Dexin Lianbang Chemical Industry Co., Ltd. under POP-H45;

1,4-butanediol (1,4-BDO): chain extender;

Distilled water (H2O): foaming agent;

Catalyst A: amine gel-type catalyst, Dabco S 25B from Air product;

Foam stabilizer: Niax L5302 from WITCO Chemical Co.,

Isocyanate prepolymer component (NCO%=20%) , obtained by reaction of diphenylme-thane-4,4′-diisocyanate and carbodiimide-modified diphenylmethane-4,4′-diisocyanate with polyether polyols having 13 wt % EO (blocked) and a number average molecular weight of about 4,800 and a functionality of 3; available from BASF Polyurethane (China) Co., Ltd. under Elastopan CS9500 C-B.

The E-TPU particles are oval particles with a diameter of about 4-5 mm and a density of 210 kg/m³, trade name Infinergy™ obtained from BASF Polyurethanes Specialty Products Co., Ltd

### Comparative Example

The polyol component in Table 1 below was premixed with chain extender (1,4-BDO), catalyst (Dabco S 25B), foaming agent (distilled water), foam stabilizer (Niax L5302) to obtain premixed polyol composition (453.3 g). The isocyanate prepolymer component (346.7 g) and the premixed polyol composition were respectively added into the corresponding charging barrel of a low-pressure casting machine and preheated to 40° C. respectively. Steel mold with a centrifuge was opened and set at 50° C. The isocyanate prepolymer component and the premixed polyol composition were poured into a rotating mold through stirring head of the low-pressure casting machine (N-type two-component pouring machine of Taiwan Green Industries Co., Ltd.). After aging for 4 minutes, the mold was opened to obtain the molded tire.

### Example 1

E-TPU particles (73.6 g) were preliminarily put into the mold, then the mold was closed and the centrifuge was turned on to rotate the mold. The temperature of the mold was set at 50° C. The polyol component in Table 1 below was premixed with chain extender (1,4-BDO), catalyst (Dabco S 25B), foaming agent (distilled water), foam stabilizer (Niax L5302) to obtain premixed polyol composition (372.1 g). The isocyanate prepolymer component (290.6 g) and the premixed polyol composition were respectively added into the corresponding charging barrel of a low-pressure casting machine and preheated to 40° C. respectively. The isocyanate prepolymer component and the premixed polyol composition were poured into a rotating mold through stirring head of the low-pressure casting machine (N-type two-component pouring machine of Taiwan Green Industries Co., Ltd.). After aging for 4 minutes, the mold was opened to obtain the molded tire.

### Example 2

E-TPU particles (128 g) were preliminarily put into the mold, then the mold was closed and the centrifuge was turned on to rotate the mold. The temperature of the mold was set at 50° C. The polyol component in Table 1 below was premixed with chain extender (1,4-BDO), catalyst (Dabco S 25B), foaming agent (distilled water), foam stabilizer (Niax L5302) to obtain premixed polyol composition (285.2 g). The isocyanate prepolymer component (226.8 g) and the premixed polyol composition were added into the corresponding charging barrel of a low-pressure casting machine and preheated to 40° C. respectively. The isocyanate prepolymer component and the premixed polyol composition were poured into a rotating mold through stirring head of the low-pressure casting machine (N-type two-component pouring machine of Taiwan Green Industries Co., Ltd.). After aging for 4 minutes, the mold was opened to obtain the molded tire.

The sheets for testing the physical properties were prepared by respectively injecting the corresponding isocyanate prepolymer component and the premixed polyol composition of the above Comparative Examples and Examples into a test piece mold of 20 cm*15 cm*1 cm under the corresponding test conditions. In preparing the test pieces of Example 1 and Example 2, the corresponding weight proportions of E-TPU particles were preliminarily put in a mold and then the corresponding isocyanate prepolymer component and premixed polyol composition were injected.

### Example 3

E-TPU particles (53.6 g) were preliminarily put into the textured tire mold, then the mold was closed and the centrifuge was turned on to rotate the mold. Non-expanded elastomeric polyurethane composition (320 g) (Elastopan CS7579/128 C-A & Elastopan CS9500 C-B from BASF Polyurethane (China) Co., Ltd.) was firstly injected to cover the pattern area completely and then waited for 40 seconds. The outer tire was in a semi-cured state and the mold was allowed to continue to rotate. The corresponding isocyanate prepolymer component (211.3) and premixed polyol composition (271 g) of Example 1 was then poured into the mold. Double-density integrated tire was taken out after aging for 4 minutes.

TABLE 1

| | | | | Example 3 |
|---|---|---|---|---|
| | | | | (Inner tire of |
| | Comparative | | | double-density |
| Samples | Example | Example 1 | Example 2 | integrated tire) |
| Polyol-A (wt %) | 50.85 | 50.80 | 50.75 | 50.80 |
| Polyol-B (wt %) | 15.00 | 15.00 | 15.00 | 15.00 |
| Polyol-C (wt %) | 20.00 | 20.00 | 20.00 | 20.00 |
| 1,4-BDO (wt %) | 10.00 | 10.00 | 10.00 | 10.00 |
| Dabco S 25B (wt %) | 3.50 | 3.50 | 3.50 | 3.50 |
| Niax L5302 (wt %) | 0.20 | 0.20 | 0.20 | 0.20 |
| Distilled water (wt %) | 0.45 | 0.50 | 0.55 | 0.50 |
| Isocyanate prepolymer | NCO value = | NCO value = | NCO value = | NCO value = |
| component (Elastopan | 20% | 20% | 20% | 20% |
| CS9500 C-B) | (346.7 g) | (290.6 g) | (226.8 g) | (211.3 g) |
| Ratio by weight of pre- | 100/76.5 | 100/78 | 100/79.5 | 100/78 |
| mixed polyol composition | | | | |
| to isocyanate prepolymer | | | | |
| component (P/I) | | | | |
| E-TPU particles | No | 10 wt % of | 20 wt % of | 10 wt % of |
| | | inner tire | inner tire | inner tire |
| | | (73.6 g) | (128 g) | (53.6 g) |
| Density of inner tire, kg/m³ | 500 | 460 | 400 | 460 |

Note:
the premixed polyol composition includes polyols, 1,4-BDO, Dabco S 25B, Niax L5302, and distilled water.

TABLE 2
The physical properties of the tires obtained according
to the Comparative examples and Examples.

| | Comparative | | | Measurement |
|---|---|---|---|---|
| | Example | Example 1 | Example 2 | standards |
| Density of test | 500 | 460 | 400 | DIN EN ISO |
| piece, kg/m³ | | | | 845 |
| Shore A | 53 | 54 | 55 | ASTM D2240 |
| Hardness | | | | |
| Tensile Strength, | 30 | 31 | 33 | DIN 53504 |
| kg/cm² | | | | |
| Tear strength, | 17 | 18 | 21 | DIN ISO |
| kg/cm² | | | | 34-1 |
| | | | | (Method B) |
| Compression | 14 | 11 | 10 | ASTM D395 |
| Resistance, % | | | | |
| Vertical rebound | 43 | 50 | 55 | ASTM D2632 |
| resilience, % | | | | |

Thus , it can be seen that the tires produced by the method of the present invention have low density, light weight and good rebound resilience, while other physical properties remain comparable and even better.

It will be apparent to those skilled in the art that various modifications and variations can be made in the present invention without departing from the scope or spirit of the invention. Thus, it is intended that the present invention cover such modifications and variations as come within the scope of the appended claims and their equivalents.

1. A non-pneumatic tire, comprising:
60-90 wt. % of a polyurethane matrix and 10-40 wt. % of expanded thermoplastic elastomer particles, the weight percentages being based on the weight of the non-pneumatic tire.

2. The non-pneumatic tire according to claim 1, wherein the non-pneumatic tire comprises 80 to 90 wt. % of the polyurethane matrix and 10 to 20 wt. % of the expanded thermoplastic elastomer particles.

3. The non-pneumatic tire according to claim 1, wherein the expanded thermoplastic elastomer particles are expanded thermoplastic polyurethane particles.

4. The non-pneumatic tire according to claim 1, wherein the non-pneumatic tire has a Shore A hardness of 40 to 90.

5. The non-pneumatic tire according to claim 1, wherein the non-pneumatic tire has a rebound resilience of 45-65%.

6. The non-pneumatic tire according to claim 1, wherein the non-pneumatic tire has a density of 300 to 900 kg/m³.

7. The non-pneumatic tire according to claim 1, wherein the expanded thermoplastic elastomer particles have a diameter of 1 to 15 mm.

8. The non-pneumatic tire according to claim 1, wherein the expanded thermoplastic elastomer particles have a density of 200 to 300 kg/m³.

9. The non-pneumatic tire according to claim 1, wherein the expanded thermoplastic elastomer particles are spherical or oval.

10. The non-pneumatic tire according to claim 1, wherein the polyurethane matrix is in the form of a foam or compacted elastomer.

11. The non-pneumatic tire according to claim 1, wherein the non-pneumatic tire is an inner tube or a double-density integrated tire.

12. A method of producing the non-pneumatic tire of claim 1, comprising:
(1) placing expanded thermoplastic elastomer particles in a mold;
(2) injecting a polyurethane matrix into the mold and curing; and
(3) demoulding.

13. A vehicle comprising the non-pneumatic tire according to claim 1.

14. The vehicle according to claim 13, wherein the vehicle is a vehicle having a speed of less than 40 km/h.

15. The vehicle according to claim 13, wherein the vehicle is a vehicle having a speed of less than 30 km/h.

16. The vehicle according to claim 13, wherein the vehicle comprises at least one selected from the group consisting of a bicycle, a monocycle, a trolley, a construction vehicle, a lawnmower, a golf trolley, a haul truck, a wheelchair, an electric scooter, a scooter, and an electric bicycle.

17. The non-pneumatic tire according to claim 1, wherein the non-pneumatic tire has a Shore A hardness of 54 to 56.

18. The non-pneumatic tire according to claim 1, wherein the expanded thermoplastic elastomer particles have a diameter of 4 to 7 mm.

19. The non-pneumatic tire according to claim 1, wherein the non-pneumatic tire is a double-density integrated tire comprising a textured outer tire portion and an inner tire portion.
